(19) United States
(12) Patent Application Publication
(10) Pub. No.: US 2024/0320798 A1
(43) Pub. Date: Sep. 26, 2024

(54) IMAGE PROCESSING METHOD, IMAGE PROCESSING APPARATUS, METHOD FOR MAKING LEARNED MODEL, LEARNING APPARATUS, IMAGE PROCESSING SYSTEM, AND STORAGE MEDIUM

(71) Applicant: CANON KABUSHIKI KAISHA, Tokyo (JP)

(72) Inventor: YOSHINORI KIMURA, Tochigi (JP)

(21) Appl. No.: 18/591,265

(22) Filed: Feb. 29, 2024

(30) Foreign Application Priority Data
Mar. 23, 2023 (JP) 2023-046288
Dec. 28, 2023 (JP) 2023-222084

(51) Int. Cl. G06T 5/60

(52) U.S. Cl. CPC G06T 5/60; G06T 2207/20081; G06T 2207/20084

(57) ABSTRACT

An image processing method includes a first step of acquiring a first image and first image information about an imaging condition or a development condition corresponding to the first image, and a second step of generating a second image by enhacing the first image using a quantized machine learning model. In the second step, either the first image information or predetermined second image information is used as information to generate the second image, and a determination of whether to use either the first image information or the predetermined second image information as the information to generate the second image is based on a value relating to the first image information and a first threshold.

### BACKGROUND

### Technical Field

One of the aspects of the embodiments relates to an image processing method, an image processing apparatus, a method for making a learned (or trained) model, a learning apparatus, an image processing system, and a storage medium.

### Description of Related Art

Japanese Patent Laid-Open No. 2021-90129 discloses a method of restoring an image degraded by encoding using a machine learning model created by learning with deep learning (DL). Japanese Patent Laid-Open No. 2020-191046 discloses a method of reducing noises in an image using a machine learning model that can be installed in a terminal such as a camera or a smartphone.

Japanese Patent Laid-Open No. 2021-90129 does not disclose a method for applying to a quantized machine learning model. Thus, the method disclosed in Japanese Patent Laid-Open No. 2021-90129 cannot execute proper image processing with fewer harmful effects associated with quantization.

By preparing a plurality of machine learning models, the method disclosed in Japanese Patent Laid-Open No. 2020-191046 can execute image processing having few harmful effects even if the machine learning models are quantized. However, due to the limited memory capacity on the terminal, it is practically difficult to prepare the plurality of machine learning models. Thus, the method disclosed in Japanese Patent Laid-Open No. 2020-191046 has difficulty in performing proper image processing with few harmful effects caused by quantization.

### SUMMARY

An image processing method according to one aspect of the disclosure includes a first step of acquiring a first image and first image information about an imaging condition or a development condition corresponding to the first image, and a second step of generating a second image by enhancing the first image using a quantized machine learning model. In the second step, either the first image information or predetermined second image information is used as information to generate the second image, and a determination of whether to use either the first image information or the predetermined second image information as the information to generate the second image is based on a value relating to the first image information and a first threshold. A non-transitory computer-readable storage medium storing a program that causes a computer to execute the above image processing method and an image processing apparatus corresponding to the above image processing method also constitute another aspect of the disclosure.

A learning apparatus according to another aspect of the disclosure includes an image acquiring unit configured to acquire a first patch and a ground truth patch corresponding to the first patch, an information acquiring unit configured to acquire first image information about an imaging condition or a development condition corresponding to the first patch, a learning unit configured to generate a second patch by enhancing the first patch using a machine learning model based on the first patch and the first image information, and to train the machine learning model based on an error between the second patch and the ground truth patch, a quantizing unit configured to quantize the machine learning model, and a determining unit configured to determine a first threshold and a machine learning model having the smallest quantization error among a plurality of machine learning models trained by changing the first image information. A method of making a learned model corresponding to the above learning apparatus also constitutes another aspect of the disclosure. A non-transitory computer-readable storage medium storing a program that causes a computer to execute the above method also constitutes another aspect of the disclosure.

An image processing apparatus according to another aspect of the disclosure communicable with the above learning apparatus includes an image acquiring unit configured to acquire a first image, an information acquiring unit configured to acquire first image information about an imaging condition or a development condition corresponding to the first image, an image processing unit configured to generate a second image using the quantized machine learning model, and a determining unit configured to determine whether to use either the first image information or predetermined second image information as information to generate the second image based on a value relating to the first image information and a first threshold. The image processing unit enhances the first image using the machine learning model and the first image information or the second image information.

An image processing system according to another aspect of the disclosure includes the above image processing apparatus, and a processor communicable with the image processing apparatus. The processor includes a transmitter configured to transmit a request for causing the image processing apparatus to execute processing for a captured image. The image processing apparatus includes a receiver and an image processing unit. The receiver receives the request transmitted by the transmitter. The image processing unit executes the processing for the captured image according to the request.

Further features of various embodiments of the disclosure will become apparent from the following description of embodiments with reference to the attached drawings.

### BRIEF DESCRIPTION OF THE DRAWINGS

FIG. 1 illustrates a learning flow of a convolutional neural network according to Example 1.

FIG. 2 is a block diagram of an image processing system according to Example 1.

FIG. 3 is an external view of the image processing system according to Example 1.

FIG. 4 is a flowchart for learning of the convolutional neural network according to Example 1.

FIG. 5 is a flowchart for generating an output image using the convolutional neural network according to Example 1.

FIG. 6 is a block diagram of an image processing system according to Example 2.

FIG. 7 is an external view of the image processing system according to Example 2.

FIG. 8 is a block diagram of an image processing system according to Example 3.

FIG. 9 is a flowchart for generating an output image using the convolutional neural network according to Example 3.

FIG. 10 explains an outline of each embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure.

Prior to a specific description, a description will now be given of the gist of each example. A quantized machine learning model can provide estimation (image processing) using the machine learning model on a user terminal (edge devices) such as a camera and a smartphone, where it is difficult to calculate a numerical value with high bit precision. In addition, high-speed estimation can be provided by calculating a numerical value with low bit precision. On the other hand, the quantized machine learning model may be able to cause harmful effects such as steps at a gradation part. This is because the reduced number of bits precision of a weight can provide only approximate numerical expressions and calculations, and such a filter applied to an input image has difficulty in expressing fine numerical changes such as gradation parts in an output image (or degraded expressive power of the model).

Accordingly, each example executes proper image processing with few harmful effects using a quantized machine learning model. A convolutional neural network is used to train the machine learning model according to each example. The convolutional neural network uses a filter to be convolved with an image, a bias to be added to the image, and an activation function for nonlinear transformation. The filter and bias are called weights and are generated by learning from training images (training data). For example, in training a machine learning model that performs image upscaling, a low-resolution image and a corresponding high-resolution image with a large number of vertical and horizontal pixels are used as training images. In addition to them, image information may be used for learning. Details of the image information about the training images and learning using the image information will be described below. Quantizing a machine learning model means expressing weights using a lower number of bits precision. For example, during learning, the weights of the machine learning model, which are generally expressed with 32-bit precision, may be expressed with 8-bit precision.

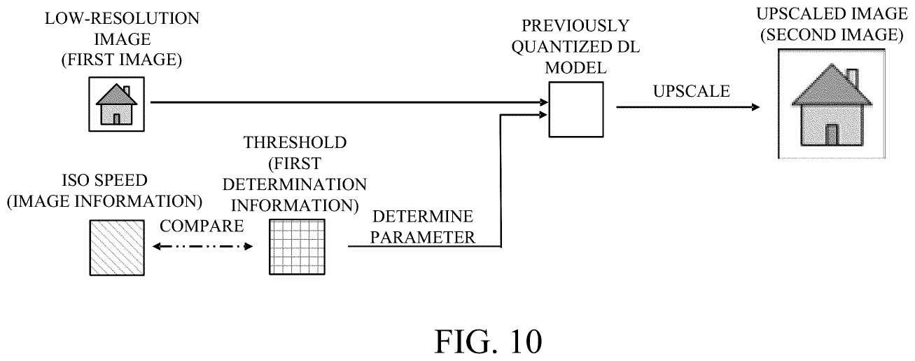

Referring now to FIG. 10, a description will be given of an overview of each example using a machine learning model that performs image upscaling as an example. FIG. 10 explains the outline of each example. In each example, first, a low-resolution image (first image) and the sensor sensitivity (ISO speed or sensitivity) during imaging as the image information (first image information) are acquired. The ISO speed and a threshold (first threshold) are compared to determine a parameter to be used for upscaling. For example, in a case where the ISO speed is equal to or less than the threshold, the ISO speed (first image information) is used as a parameter. On the other hand, in a case where the ISO speed is greater than the threshold, the threshold (second image information that is predetermined) is used as a parameter. Finally, an image (second image) is generated by upscaling (sharpening or enhancing) the low-resolution image (first image) using a quantized machine learning model using the low-resolution image and the parameter.

Here, the first image information is a value that depends on image information such as the ISO speed. Image information itself such as the ISO speed may be used as the first image information. The second image information that is predetermined is a fixed value based on the first threshold or a fixed value that does not depend on the image information. The first threshold is a value relating to image information. The machine learning model is previously trained using training images that have image information that is equal to or less than the first threshold (equal to or less than the threshold). Image sharpening (enhancing) may be, for example, but not limited to, upscaling of a low-resolution image, and may also be other image processing such as deblurring for a blurred image or noise reduction for a noisy image.

In each example, the machine learning model is previously quantized. That is, the weights for the machine learning model, which are expressed with 32-bit precision during learning, are expressed with 8-bit precision and used for estimation. Here, estimation means generating a sharp (enhanced) image close to a ground truth image from an input image through image processing. For example, in the case of DL upscaling, it refers to generating an upscaled image close to a ground truth high-resolution image from a low-resolution image using a machine learning model.

In each example, a machine learning model with the minimum quantization error among a plurality of quantized learned machine learning models is used for estimation. In other words, a plurality of machine learning models is trained by using the training image having various image information, and a machine learning model having a minimum error (quantization error) after the same image is processed with these machine learning models before and after quantization is used for estimation. For example, in the case of upscaling, a plurality of machine learning models is trained using training images having different ISO speed ranges, and the machine learning model having the smallest quantization error is used for estimation.

In each example, the upper limit value of the image information range about the training images for training the machine learning model that is used for estimation is used as a threshold (first threshold) for estimation. For example, in a case where ISO speed is used as the image information about the training image and a machine learning model trained with the training images in the range of ISO 100 to 3200 is quantized and used for estimation, the threshold becomes ISO 3200. A first threshold may be determined so that the quantization error in quantizing the machine learning model is minimum (it is the value when the quantization error is minimum).

Thereby, each example can perform proper image processing with fewer harmful effects using the quantized machine learning model. In the case of upscaling, training images with high ISO speed contain a lot of noises, and the machine learning model trained using it needs to be trained to create high-frequency noise components, so the machine learning model requires a high level of expressiveness. In a case where this machine learning model is quantized, the expressive power of the model is degraded, and the harmful effect is caused by the quantization error during estimation. On the other hand, each example trains the machine learning model by varying the ISO speed range for the training images, and the machine learning model with small quantization error is used for estimation, so there are fewer harmful effects associated with the quantization of the machine learning model and images can be upscaled properly.

In upscaling an image with an ISO speed outside the range of the training images that were used for learning, the upper limit value (first threshold) of the ISO speed in the learning range is used as a parameter (second image information that is predetermined). For example, in quantizing a machine learning model trained with training images of ISO 100 to 3200 and DL upscaling an image of ISO 12800, ISO 3200 is used as a parameter. Thereby, the image quality of a DL upscaled image at a high ISO speed is degraded (because an image at ISO 12800 is processed as an image at ISO 3200). However, an image at high ISO speed is originally noisy and has low image quality, and thus the influence on the image quality of the DL upscaled image is insignificant.

The image processing method described above is merely illustrative, and each example is not limited to this implementation. Details of other image processing methods will be described in each example below.

### Example 1

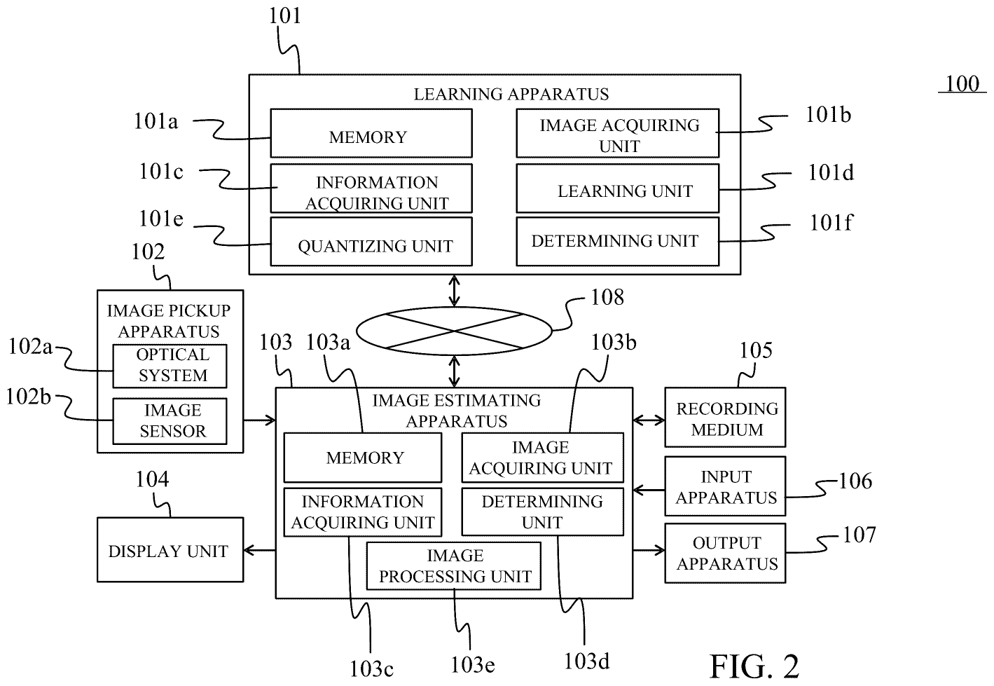

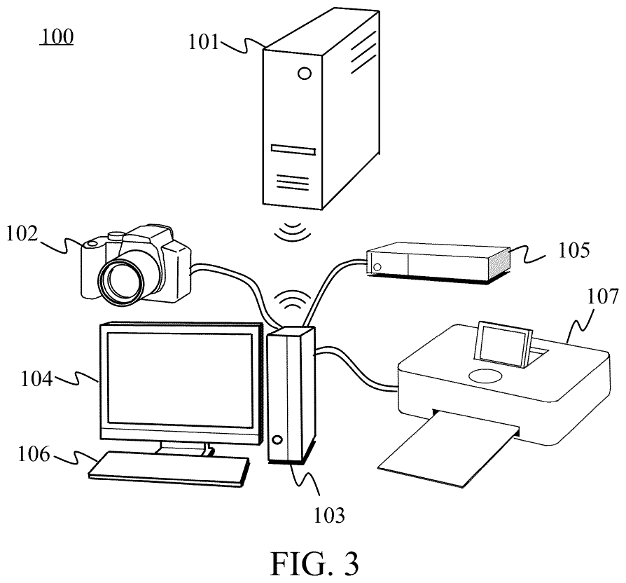

Referring now to FIGS. 2 and 3, a description will be given of an image processing system 100 according to Example 1. In this example, image processing for generating an upscaled image of a captured image (low-resolution image) is learned and executed using a quantized machine learning model.

FIG. 2 is a block diagram of the image processing system 100. FIG. 3 is an external view of the image processing system 100. The image processing system 100 includes a learning apparatus 101, an image pickup (capture) apparatus 102, an image estimating apparatus 103, a display apparatus 104, a recording medium 105, an input apparatus 106, an output apparatus 107, and a network 108.

The learning apparatus 101 includes a memory 101a, an image acquiring unit 101b, an information acquiring unit 101c, a learning unit 101d, a quantizing unit 101e, and a determining unit 101f.

The image pickup apparatus 102 includes an optical system (imaging optical system) 102a and an image sensor 102b. The optical system 102a focuses light that has entered the image pickup apparatus 102 from the object space. The image sensor 102b receives an optical image of an object formed through the optical system 102a, and obtains a captured image (low-resolution image). The image sensor 102b is a CCD (Charge Coupled Device) sensor, a CMOS (Complementary Metal-Oxide Semiconductor) sensor, or the like. The image pickup apparatus 102 can acquire information about an imaging condition of a captured image (pixel pitch of the image sensor 102b, type of an optical low-pass filter, ISO speed, etc.) together with the image. The image pickup apparatus 102 can also acquire the development condition (noise reduction intensity, sharpness intensity, image compression rate, etc.) of the captured image along with the image. The image pickup apparatus 102 can transmit at least one piece of image information about an imaging condition or development condition acquired with an image to an information acquiring unit 103c of the image estimating apparatus 103, which will be described below, together with the image. The image pickup apparatus 102 further includes a memory that stores acquired images, a display unit that displays images, a transmitter that transmits images to an external apparatus, and an output unit (not illustrated) that stores images in a storage medium in the external apparatus. The image pickup apparatus 102 further includes a control unit (not illustrated) that controls each component in the image pickup apparatus 102.

The image estimating apparatus 103 includes a memory 103a, an image acquiring unit 103b, the information acquiring unit 103c, a determining unit 103d, and an image processing unit (image estimating unit) 103e. The determining unit 103d determines a parameter based on a low-resolution image (captured image, first image) acquired by the image acquiring unit 103b and image information about the low-resolution image acquired by the information acquiring unit 103c. The image processing unit 103e performs image processing to generate a high-resolution image (output image, second image) by upscaling (sharpening or enhancing) the low-resolution image based on the parameter determined by the determining unit 103d. The low-resolution image may be either an image captured by the image pickup apparatus 102 or an image stored in the recording medium 105.

A machine learning model that has been previously quantized is used for image processing, and its weights information is read out of the memory 103a. The weights are learned by the learning apparatus 101, and the image estimating apparatus 103 has previously read weight information out of the memory 101a via the network 108 and stored it in the memory 103a. The weight information to be stored may be either the weight value itself or its encoded form. Details regarding weight learning and image processing using the weights will be described below.

The upscaled image is output to at least one of the display apparatus 104, the recording medium 105, and the output apparatus 107. The display apparatus 104 is, for example, a liquid crystal display or a projector. The user can check the image being processed via the display apparatus 104 and perform an image editing operation via the input apparatus 106. The recording medium 105 is, for example, a semiconductor memory, a hard disk drive, a server on a network, or the like. The input apparatus 106 is, for example, a keyboard or a mouse. The output apparatus 107 is, for example, a printer.

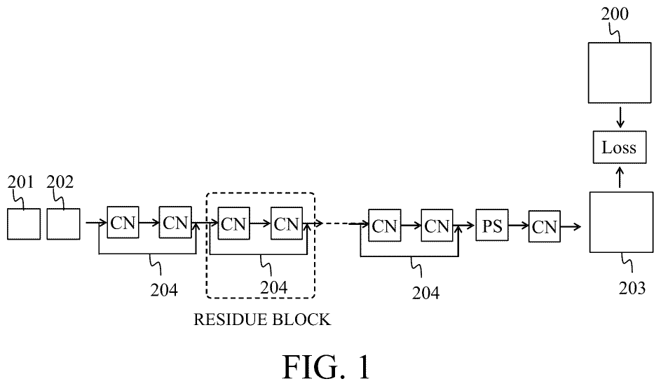

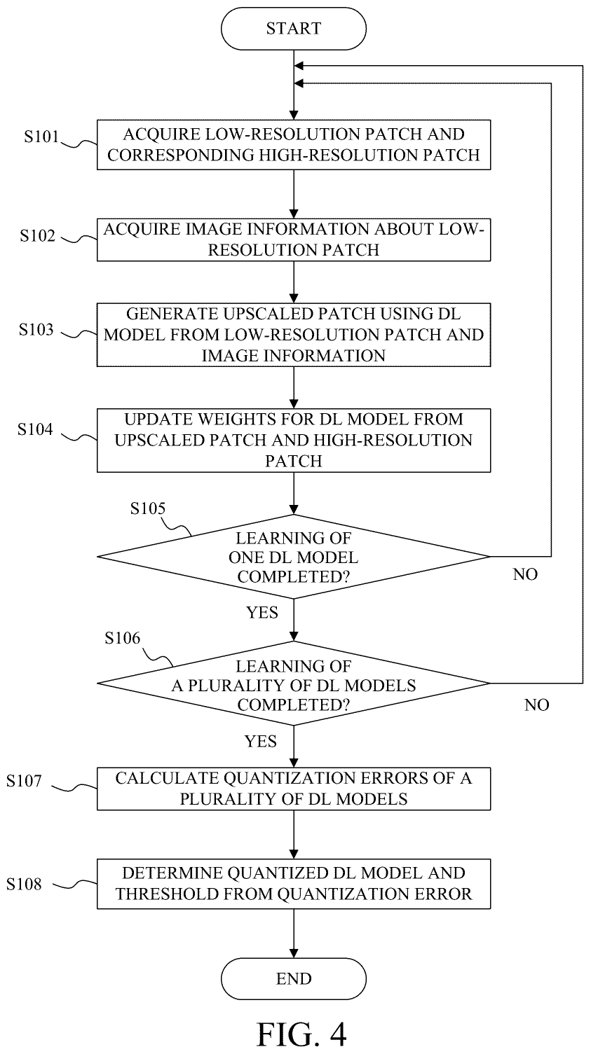

Referring now to FIGS. 1 and 4, a description will be given of a weight learning method (a method for making a trained model) executed by the learning apparatus 101 in this example. FIG. 1 illustrates the flow of updating a weight of a machine learning model (training of a convolutional neural network). FIG. 4 is a flowchart for weight learning. Each step in FIG. 4 is mainly executed by the image acquiring unit 101b, the information acquiring unit 101c, the learning unit 101d, the quantizing unit 101e, and the determining unit 101f.

First, in step S101, the image acquiring unit 101b acquires a low-resolution patch (first patch) 201 and a high-resolution patch (ground truth patch) 200 corresponding to the low-resolution patch 201, as illustrated in FIG. 1. In this example, a patch is an image having a predetermined number of pixels. For example, a low-resolution patch has 128×128×3 pixels in a vertical×horizontal×depth (channel) direction, and a corresponding high-resolution patch has 256×256×3 pixels. In this case, since the vertical and horizontal lengths are twice, the upscale factor (magnification ratio) is 2 times (magnified by 4 times in terms of the number of pixels). The upscale factor is not limited to 2 times, but may be any magnification ratio as long as a high-resolution patch corresponding to a low-resolution patch can be obtained.

In this example, the low-resolution patch and the high-resolution patch are three-channel color images with RGB information, but this example is not limited to this implementation. For example, a one-channel monochrome image with luminance information may be used. Alternatively, a high-resolution patch corresponding to a low-resolution patch may be obtained by imaging the same object using optical systems with different focal lengths and clipping corresponding parts of the two obtained images. Alternatively, a low-resolution patch corresponding to a patch acquired by the image pickup apparatus 102 and a corresponding high-resolution patch that is less affected by blur (aberration and diffraction) caused by the optical system 102a may be generated by numerical simulation. In this example, the low-resolution patch and the corresponding high-resolution patch are generated by numerical simulation, but this example is not limited to this implementation.

Next, in step S102, the information acquiring unit 101c acquires the image information 202 of the low-resolution patch (first patch) 201. This example uses, but is not limited to, the ISO speed (sensor sensitivity) of the image sensor 102b) that was set when the low-resolution patch 201 is generated by numerical simulation, as the image information 202. For example, in addition to or in place of the ISO speed, noise reduction intensity, sharpness intensity, image compression rate, etc. during image development may be used as image information.

Next, in step S103, the learning unit 101d generates an upscaled patch (second patch) 203 from the low-resolution patch (first patch) 201 and image information 202 (ISO speed) using a machine learning model. The upscaled patch (second patch) 203 is an estimate of the high-resolution patch (ground truth patch) 200, and both are ideally identical.

In this example, the low-resolution patch (first patch) and its ISO speed are input to the machine learning model. As an input method, this example concatenates (connects) images having ISO speed as pixel values and inputs them in a depth (channel) direction of the low-resolution patch (first patch) 201, but this example is not limited to this method. Inputting the ISO speed together with the low-resolution patch (first patch) 201 to the machine learning model can provide processing according to the ISO speed. For example, in a case where the ISO speed is low, upscaling can be performed to emphasize high-frequency components of the object, and in a case where the ISO speed is high, upscaling can be performed to create the high-frequency noise components lost due to noise reduction during development.

Next, in step S104, the learning unit 101d updates the weights of the machine learning model based on an error between the high-resolution patch (ground truth patch) 200 and the upscale patch (second patch) 203 as its estimation. Here, the weights include a filter and a bias for each layer of the convolutional neural network, and are generally expressed with 32-bit precision. Although an error backpropagation method (Backpropagation) is used to update the weights, this example is not limited to this implementation. In mini-batch learning, the error between the high-resolution patch (ground truth patch) 200 and the upscale patch (second patch) 203 corresponding to the high-resolution patch 200 is determined, and the weights are updated. For example, the L2 norm or the L1 norm may be used for the error function (loss function). The weight updating method (learning method) is not limited to mini-batch learning, and may be other learning such as batch learning or online learning.

Next, in step S105, the learning unit 101d determines whether learning of the weights (one machine learning model) is completed (terminated). The completion can be determined based on whether the number of repetitions of learning (updating weights) has reached a predetermined value, or whether a change amount in a weight during updating is smaller than a specified value. In a case where it is determined that learning has not been completed, the flow returns to step S101 and a plurality of pairs of new low-resolution patches (first patch) 201 and corresponding high-resolution patches 200 (ground truth patches) are acquired. On the other hand, in a case where it is determined that learning has been completed, the weight information is stored in the memory 101a.

Next, in step S106, the learning unit 101d determines whether training the plurality of machine learning models has been completed. In a case where it is determined that training the plurality of machine learning models has not yet been completed, steps S101 to S105 are repeated. That is, the learning unit 101d changes the range of the image information 202 of the training image, re-trains the machine learning model from step S101, and generates a plurality of models with different learned image information ranges. For example, in a case where the ISO speed is used as the image information 202, the ISO speed range of 100 to 12800 is changed to a range of 100 to 3200. A low-resolution patch and a corresponding high-resolution patch are generated by numerical simulation in the ISO speed range of 100 to 3200, and a machine learning model is trained. This example uses the ISO speed as the image information 202, but is not limited to this implementation. For example, in addition to or in place of the ISO speed, noise reduction intensity, sharpness intensity, or image compression rate during image development may be used as the image information 202.

On the other hand, in a case where it is determined in step S106 that training the plurality of machine learning models has been completed, the flow proceeds to step S107. In step S107, the quantizing unit 101e quantizes the plurality of machine learning models having different learned image information ranges and calculates a quantization error. The quantization means expressing the weights of a machine learning model, which is generally learned with 32-bit precision, with lower bit precision such as 16-bit or 8-bit precision. This step may be omitted in a case where a machine learning model that originally has a weight of low bit precision, such as 8-bit precision, is trained by an arbitrary method. The quantization error is an error that occurs in a case where the same image is processed using pre-quantization and post-quantization machine learning models.

Next, in step S108, the determining unit 101f determines a quantized machine learning model and a threshold (first threshold) to be used for the estimation. In this example, a quantized machine learning model with a minimum quantization error is used for the estimation, but the example is not limited to this implementation. For example, in a case where the quantization error is reduced to some extent, the machine learning model may be used for the estimation. Moreover, this example uses, as a threshold for the estimation, the upper limit value of the image information range of the training images that were used to train the machine learning model, but this example is not limited to this implementation. The threshold (first threshold) is a fixed value that does not depend on the image information about the image input to the quantized machine learning model during the estimation. For example, in a case where a machine learning model is quantized and used for the estimation, which has been trained with training images in the ISO speed range of 100 to 3200, the threshold (first threshold) can be ISO 3200, which is a fixed value that does not depend on the image information about the image input during the estimation.

While the machine learning model is trained with training images in the ISO speed range of 100 to 3200, image information about ISO 100 to 25600, for example, may be used for training. That is, learning may be performed by adding information about ISO 3200 to 25600 to the image information about the training images at ISO speed 3200, so that the resultant information exceeds the actual ISO speed. In this case, the threshold (first threshold) is ISO 3200, which is the upper limit value of the actual ISO speed range of the training images.

This example uses the configuration of the convolutional neural network illustrated in FIG. 1 for a machine learning model, but this example is not limited to this implementation. CN in FIG. 1 represents a convolutional layer. In the CN, a sum of the convolution of the input, the filter, and the bias is calculated, and the result is nonlinearly transformed with an activation function. Initial values of each component in the filter and the bias are arbitrary, and are determined by random numbers in this example. The activation function can use, for example, a Rectified Linear Unit (ReLU) or a sigmoid function. A feature map is a multidimensional array output from each layer except the final layer. Generally, the feature map is a four-dimensional array, and has dimensions of a batch, length, width, and channel. A skip connection 204 combines feature maps output from non-consecutive layers. The feature maps may be combined by summing respective elements, or by concatenating them in the channel direction. This example uses the sum of respective elements.

An element (block or module) within a dotted frame in FIG. 1 represents a residual block. A network in which residual blocks are multilayered is called a residual network, and is widely used in image processing with DL. However, this example is not limited to this implementation, and the network may be configured by layering other elements. For example, it may be an inception module in which convolution layers having different convolution filter sizes are juxtaposed and a plurality of resulting feature maps are integrated to form a final feature map. Alternatively, for example, a dense block having dense a skip connection may be used.

The processing load (mainly convolution calculation) may be reduced by down-sampling the feature map in a layer close to the input. Pooling, stride, etc. can be used to down-sample the feature map. The down-sampled feature map can be up-sampled by using deconvolution (or transposed convolution), pixel shuffle, interpolation, etc.

This example uses pixel shuffle (PS in FIG. 1) as a method for up-sampling the down-sampled (low-resolution) feature map in a layer close to the output to create a high-resolution feature map, but this example is not limited to this implementation.

In this example, the number of bits precision in at least one layer of the machine learning model may be twice or less the number of bits precision of the captured image (first image). For example, in a case where a captured image is expressed as a numerical value with 8-bit precision, a weight (filter and bias) of at least one layer of the machine learning model may be expressed as a numerical value with 16-bit precision.

In this example, the number of bits precision in at least one of the input layer and the output layer of the machine learning model may be equal to or larger than the number of bits precision of a captured image. For example, in a case where the captured image is expressed as a numerical value with 8-bit precision, the weights of the input and output layers of the machine learning model may be expressed as numerical values with 8-bit precision.

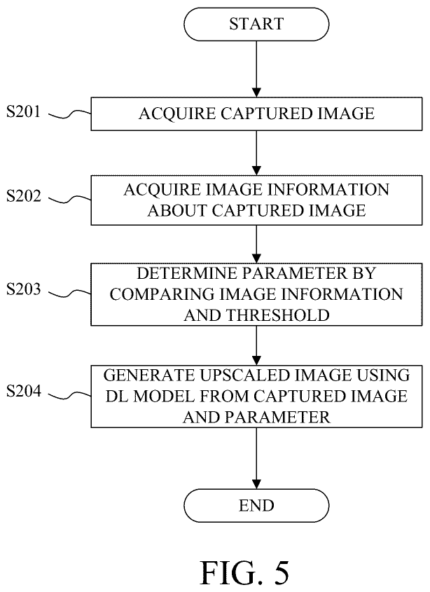

Referring now to FIG. 5, a description will be given of the estimation (upscaling of an image using a machine learning model) performed by the image estimating apparatus 103 in this example. FIG. 5 is a flowchart for generating an upscaled image from a captured image using a previously quantized machine learning model (a flowchart for generating an output image using a convolutional neural network). Each step in FIG. 5 is mainly executed by the image acquiring unit 103b, information acquiring unit 103c, determining unit 103d, or image processing unit 103e in the image estimating apparatus 103.

First, in step S201, the image acquiring unit 103b acquires a captured image (first image). The captured image is a low-resolution image similarly to that for learning. In this example, the captured image is transmitted from the image pickup apparatus 102, but this example is not limited to this implementation. For example, a captured image stored in the memory 103a may be used.

Next, in step S202, the information acquiring unit 103c acquires image information about the captured image. In this example, the image information to be acquired is, for example, ISO speed (sensor sensitivity), as in learning. However, this example is not limited to this implementation. The image information may be information that includes at least one of a type, an F-number, a focal length, an object distance, an image height, an imaging mode of lens apparatus, a type, sensor sensitivity, shutter speed, image compression during development, sharpness intensity, and noise reduction intensity of image pickup apparatus. The lens apparatus is a lens apparatus having an optical system (lens) that is used to acquire the captured image. The image height of the lens apparatus includes information about an optical characteristic for each image height (such as a modulation transfer function (MTF) and a point spread function (PSF)). The imaging mode includes, but is not limited to, a shutter priority mode and an aperture (or F-number) priority mode.

Next, in step S203, the determining unit 103d determines the parameter (first image information or second image information that is predetermined) based on the comparison between the acquired image information (for example, ISO speed) and the threshold (first threshold) determined during learning. In this example, in a case where the ISO speed is smaller than the threshold, the first image information is used as the parameter. On the other hand, in a case where the ISO speed is larger than the threshold, the second image information (threshold) that is predetermined is used as a parameter. However, this example is not limited to this implementation. For example, in addition to the ISO speed, information about the pixel pitch or imaging mode of the image pickup apparatus 102 may be acquired, and the second threshold (determination information based on image information and first threshold) acquired by adjusting the threshold determined during learning according to that information may be compared with the ISO speed. Here, the second threshold is a value relating to image information.

As described in step S108, in a case where learning has information broader than the actual image information (for example, ISO speed) of the training images for training the machine learning model, the threshold (first threshold) determined during learning may not be compared, and the first image information based on the image information about the captured image may be used as the parameter.

Next, in step S204, the image processing unit 103e generates an upscaled image (second image) from the captured image using the captured image, parameter, and previously quantized machine learning model. A convolutional neural network similar to the configuration illustrated in FIG. 1 is used to generate the upscaled image. This example inputs the captured image and the parameter together into the previously quantized machine learning model using the method described in step S104, but this example is not limited to this implementation. The weight information for the previously quantized machine learning model is transmitted from the learning apparatus 101 and stored in the memory 103a. In inputting captured image and parameter together into the previously quantized machine learning model, it is unnecessary to crop them with the same size as the low-resolution patch that was used during learning, but they may be decomposed into a plurality of overlapping patches before processing. In this case, the patches obtained after processing may be combined to form an upscale image.

In this example, in a case where image information cannot be acquired in step S202, a parameter (third image information) may be determined based on another threshold (third threshold) in step S203, and DL upscaled in step S204. The threshold (third threshold) is the lower limit value of the image information range of the training images that have been used to train the machine learning model. For example, in a case where a machine learning model trained with training images in an ISO speed range of 100 to 3200 is quantized and used for the estimation, the threshold (third threshold) is ISO100, and the parameter (third image information) is ISO100.

While the learning apparatus 101 and the image estimating apparatus 103 are separate members in this example, this example is not limited to this implementation. The learning apparatus 101 and the image estimating apparatus 103 may be integrated. That is, learning (processing illustrated in FIG. 4) and estimation (the process illustrated in FIG. 5) may be performed within a single apparatus.

This example can provide an image processing method that can perform image processing (upscaling) with fewer harmful effects using a quantized machine learning model.

### Example 2

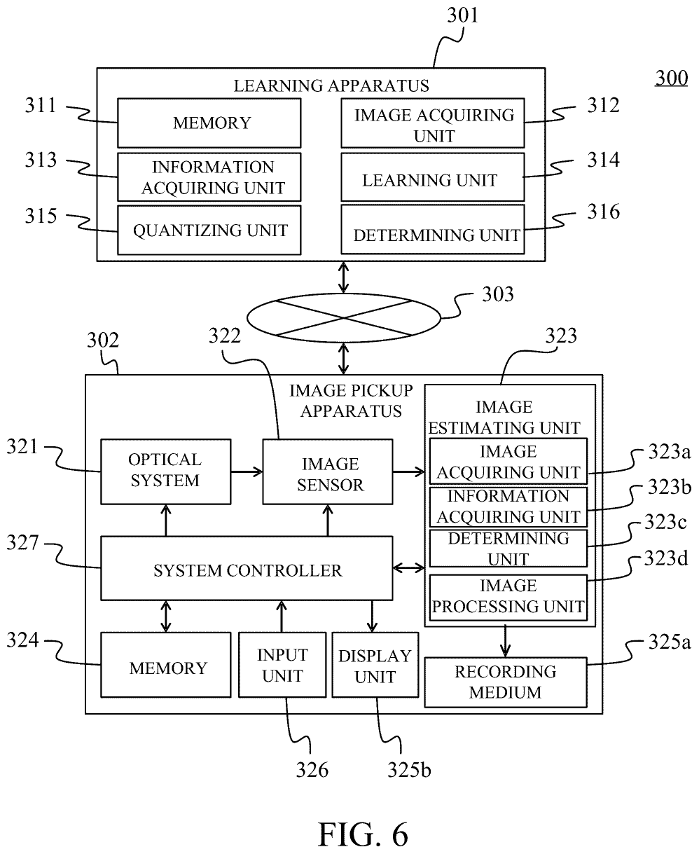

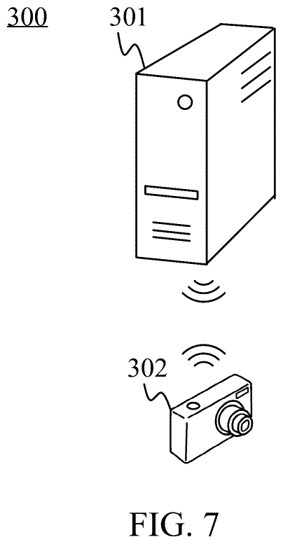

Referring now to FIGS. 6 and 7, a description will be given of an image processing system 300 according to Example 2. This example uses a machine learning model that has been previously quantized, for learning and executing image processing that reduces (removes) noise and generates a noise reduced image from a noisy captured image. This example is different from Example 1 in that the image pickup apparatus 302 acquires a captured image (noisy image) and performs image processing.

FIG. 6 is a block diagram of the image processing system 300. FIG. 7 is an external view of the image processing system 300. The image processing system 300 includes a learning apparatus (first apparatus) 301 and an image pickup apparatus (second apparatus) 302 that are connected via a network 303. The learning apparatus 301 and the image pickup apparatus 302 do not need to be always connected via the network 303.

The learning apparatus 301 includes a memory 311, an image acquiring unit 312, an information acquiring unit 313, a learning unit 314, a quantizing unit 315, and a determining unit 316. The learning apparatus 301 updates the weights for the machine learning model to perform image processing that generates a noise reduced image from a noisy captured image using the above components.

The image pickup apparatus 302 images the object space, obtains a captured image (noisy image), and generates a noise reduced image from the captured image. Details regarding the image processing performed by the image pickup apparatus 302 will be described below. The image pickup apparatus 302 includes an optical system (imaging optical system) 321 and an image sensor 322. The image estimating unit 323 includes an image acquiring unit 323a, an information acquiring unit 323b, a determining unit 323c, and an image processing unit 323d.

A description will now be given of learning of weights for a machine learning model executed by the learning apparatus 301 in this example. This example will describe weight learning with reference to FIG. 4 as to only points different from the weight learning described in Example 1, and will omit a description common to Example 1.

First, in step S101, the image acquiring unit 312 acquires a noisy patch (first patch) and a corresponding sharp patch with less noise (ground truth patch). This example generates a noisy patch and a corresponding sharp clean patch by numerical simulation, but this example is not limited to this implementation.

Next, in step S102, the information acquiring unit 313 acquires image information about the noisy patch (first patch). In this example, the ISO speed set when the noisy patch is generated by numerical simulation is used as the image information, but this example is not limited to this implementation. For example, in addition to or in place of the ISO speed, noise reduction intensity, sharpness intensity, or image compression rate during image development may be used as image information.

Next, in step S103, the learning unit 314 generates a noise reduced patch (second patch) from the noisy patch (first patch) and its image information (ISO speed) using a machine learning model. The noise reduced patch (second patch) is an estimate of the sharp clean patch (ground truth patch), and both are ideally identical. The subsequent steps S104 and S105 are substantially the same as those of Example 1, and a description thereof will be omitted.

Next, in step S106, the learning unit 314 changes the image information range of the training images, re-trains the machine learning model from step S101, and generates a plurality of models with different learned image information ranges. For example, in a case where ISO speed is used as image information, the ISO speed range of 100 to 12800 is changed to an ISO speed range of 100 to 3200. Then, a noisy patch and a corresponding sharp clean patch are generated by numerical simulation in the ISO speed range of 100 to 3200, and a machine learning model is trained. This example uses the ISO speed as the image information, but is not limited to this implementation. For example, in addition to or in place of the ISO speed, noise reduction intensity, sharpness intensity, or image compression rate during image development may be used as image information. The subsequent steps S107 and S108 are substantially the same as those of Example 1, and a description thereof will be omitted.

Next follows details regarding image processing performed by the image pickup apparatus 302. Information on weights for the previously quantized machine learning model is previously learned by the learning apparatus 301 and stored in the memory 311. The image pickup apparatus 302 reads weight information out of the memory 311 via the network 303 and stores it in the memory 324. The image estimating unit 323 generates a noise reduced image from a captured image through the image processing unit 323d using the weight information about the machine learning model stored in the memory 324, the captured image acquired by the image acquiring unit 323a, and the image information acquired by the information acquiring unit 323b. The generated noise-reduced image is stored in the recording medium 325a. In a case where a user issues an instruction to display the noise reduced image via the input unit 326, the stored image is read out and displayed on the display unit 325b. may read out the captured image and its image information stored in the recording medium 325a may be read out and the image estimating unit 323 may reduce noise. The above series of controls are performed by a system controller 327.

Next follows the noise reduction processing executed by the image estimating unit 323 in this example. The image processing procedure is substantially the same as the flowchart illustrated in FIG. 5 of Example 1. Each step of image processing is mainly executed by the image acquiring unit 323a, information acquiring unit 323b, determining unit 323c, and image processing unit 323d in the image estimating unit 323.

First, in step S301, the image acquiring unit 323a acquires a captured image (noisy image, first image). In this example, the captured image is acquired by the image pickup apparatus 302 and stored in the memory 324, but this example is not limited to this implementation. Next, in step S302, the information acquiring unit 323b acquires image information about the captured image. The image information acquired here is the ISO speed as in the learning. Next, in step S303, the determining unit 323c determines a parameter (first image information or second image information that is predetermined) based on a comparison between the acquired image information and a threshold (first threshold) determined during learning. The comparison method and the processing in a case where image information cannot be acquired are the same as those of Example 1. Next, in step S304, the image processing unit 323d generates a noise reduced image (second image) from the captured image using the captured image, parameter, and previously quantized machine learning model.

This example can provide an image processing method that can perform image processing (noise reduction) with fewer harmful effects using a quantized machine learning model.

### Example 3

A description will now be given of an image processing system 400 according to Example 3. In this example, a previously quantized machine learning model is used for learning and executing image processing that generates a deblurred image from a blurred captured image. This example is different from Examples 1 and 2 in having a processing apparatus (computer 404) configured to transmit a captured image (blurred image) as a target of image processing to an image estimating apparatus 403, and to receive an output image (deblurred image) that has been processed from the image estimating apparatus 403.

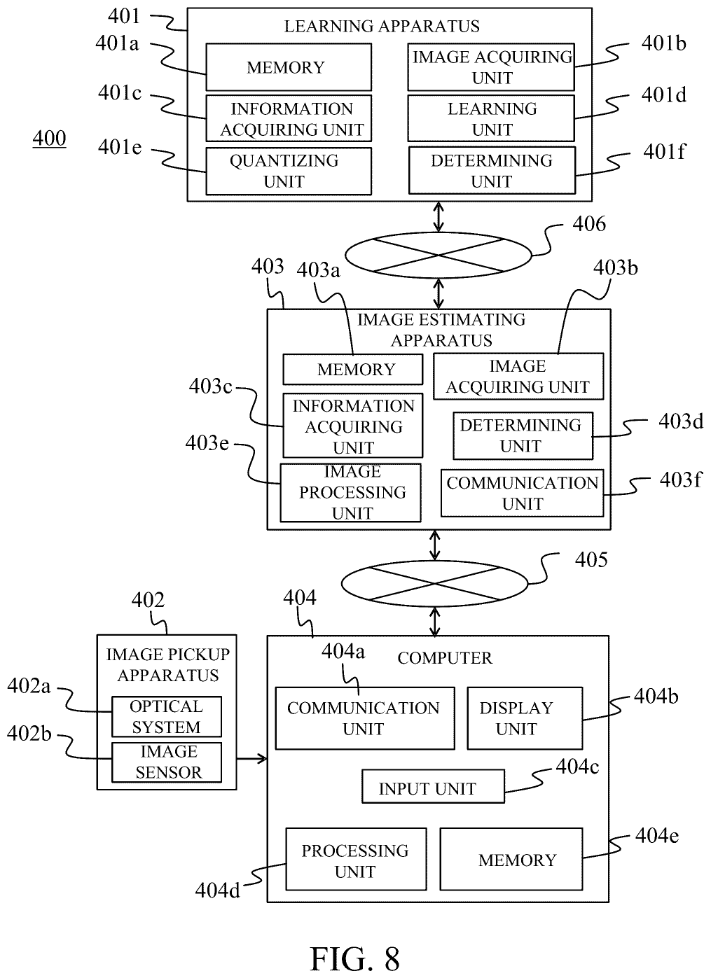

FIG. 8 is a block diagram of the image processing system 400. The image processing system 400 includes a learning apparatus (third apparatus) 401, an image pickup apparatus 402, an image estimating unit (fifth apparatus) 403, and a computer (processing apparatus, fourth apparatus) 404. The learning apparatus 401 and the image estimating apparatus 403 are, for example, servers. The computer 404 is, for example, a user terminal (such as a personal computer, smartphone, or camera). The computer 404 is connected to the image estimating apparatus 403 via a network 405. The image estimating apparatus 403 is connected to the learning apparatus 401 via a network 406. That is, the computer 404 and the image estimating apparatus 403 are configured to be communicable, and the image estimating apparatus 403 and the learning apparatus 401 are configured to be communicable.

Similarly to the learning apparatus 101 of Example 1, the learning apparatus 401 includes a memory 401a, an image acquiring unit 401b, an information acquiring unit 401c, a learning unit 401d, a quantizing unit 401e, and a determining unit 401f. The image pickup apparatus 402, like the image pickup apparatus 102 of Example 1, includes an optical system (imaging optical system) 402a and an image sensor 402b.

The image estimating apparatus 403 includes a memory 403a, an image acquiring unit 403b, an information acquiring unit 403c, a determining unit 403d, an image processing unit 403e, and a communication unit (receiver) 403f. The memory 403a, image acquiring unit 403b, information acquiring unit 403c, determining unit 403d, and image processing unit 403e are similar to the memory 103a, image acquiring unit 103b, information acquiring unit 103c, determining unit 103d, and image processing unit 103e of Example 1, respectively. The communication unit 403f has a function of receiving a request transmitted from the computer 404 and a function of transmitting an output image (deblurred image) generated by the image estimating apparatus 403 to the computer 404.

The computer 404 includes a communication unit (transmitter) 404a, a display unit 404b, an input unit 404c, a processing unit 404d, and a memory 404e. The communication unit 404a has a function of transmitting to the image estimating apparatus 403 a request for causing the image estimating apparatus 403 to execute processing for the captured image (blurred image), and a function of receiving an output image (deblurred image) processed by the image estimating apparatus 403. The display unit 404b has a function of displaying various information. The information displayed by the display unit 404b includes, for example, a captured image (blurred image) to be transmitted to the image estimating apparatus 403 and an output image (deblurred image) received from the image estimating apparatus 403. The input unit 404c receives an input from the user, such as an instruction to start the image processing. The processing unit 404d has a function of performing image processing such as noise reduction for the output image (deblurred image) received from the image estimating apparatus 403. The memory 404e stores a captured image acquired from the image pickup apparatus 402, an output image received from the image estimating apparatus 403, and the like.

A description will be given of only points different from the flowchart for weight learning described according to Example 1 with reference to FIG. 4 in the weight learning of the machine learning model executed by the learning apparatus 401 in this example.

First, in step S101, the image acquiring unit 401b acquires a blurred patch (first patch) and a sharp patch with less blur (ground truth patch) corresponding to the blurred patch. In this example, the blurred patch and the corresponding sharp clear patch are generated by numerical simulation, but this example is not limited to this implementation.

Next, in step S102, the information acquiring unit 401c acquires image information about the blurred patch (first patch). This example determines lens-specific blur (aberration and diffraction) according to an image height of an image, and generates a blurred patch by numerical simulation using a lens model (lens type), F-number, focal length, object distance, and image height of the optical system 402a as image information. However, this example is not limited to this implementation. For example, in addition to or in place of the optical information, the ISO speed of the image sensor 402b during imaging, noise reduction intensity, sharpness intensity, or image compression rate during image development, etc. may be used as image information.

Next, in step S103, the learning unit 401d generates a deblurred patch (second patch) using a machine learning model from the blurred patch (first patch) and its image information (optical information). The deblurring patch (second patch) is an estimate of the sharp clear patch (ground truth patch), and both are ideally identical. The subsequent steps S104 and S105 are substantially the same as those of Example 1, and a description thereof will be omitted.

Next, in step S106, the learning unit 401d changes the image information range for the training images, re-trains the machine learning model from step S101, and generates a plurality of models with different learned image information ranges. For example, in a case where the image height is used as the image information, the image height range is changed from the optical axis center to the 100% image height to the optical axis center to the 50% image height. The blur is determined between the optical axis center and the 50% image height as the image height range, and a blurred patch is generated by adding blur to the sharp clear patch by numerical calculation, and a machine learning model is trained. The subsequent steps S107 and S108 are substantially the same as those of Example 1, and a description thereof will be omitted.

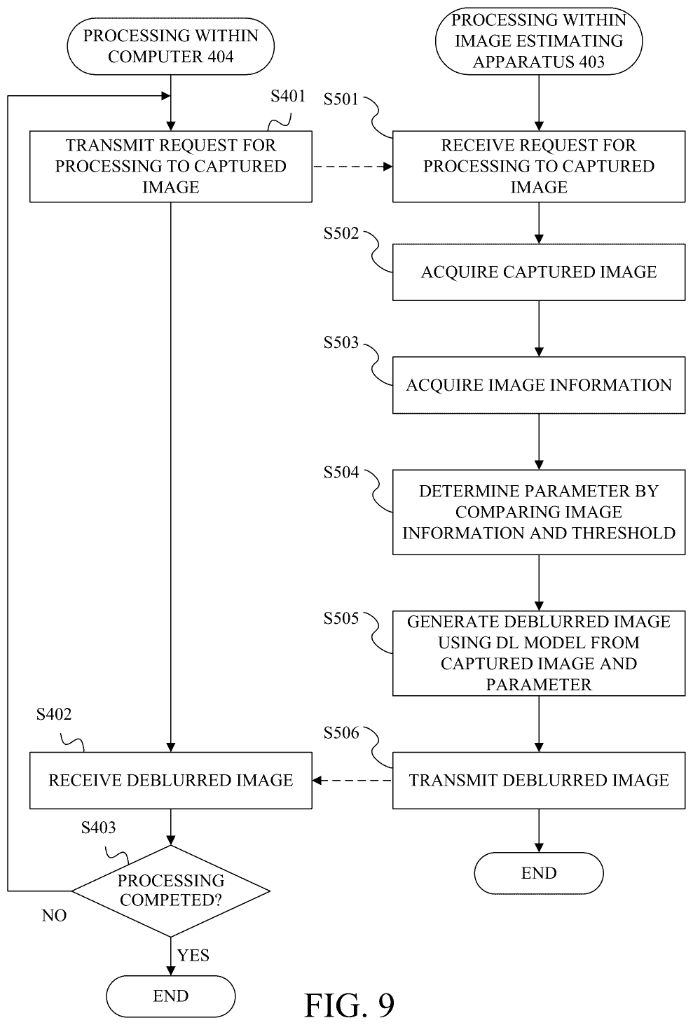

Referring now to FIG. 9, a description will be given of image processing (generation of an output image using a convolutional neural network) in this example. FIG. 9 is a flowchart for image processing in this example. The image processing in FIG. 9 is started when the user issues an instruction to start image processing via the computer 404.

The operation of the computer 404 will now be described. First, in step S401, the computer 404 transmits a request for processing a captured image (blurred image, first image) to the image estimating apparatus 403. Any methods of transmitting the captured image to be processed and its image information to the image estimating apparatus 403 may be used. For example, the captured image and its image information may be uploaded to the image estimating apparatus 403 simultaneously with or before step S401. The captured image may be an image stored on a server different from the image estimating apparatus 403. In step S401, the computer 404 may transmit an ID for authenticating the user together with a request for processing the captured image. Next, in step S402, the computer 404 receives the output image (deblurred image) generated within the image estimating apparatus 403.

The operation of the image estimating apparatus 403 will now be described. First, in step S501, the image estimating apparatus 403 receives a request for processing a captured image transmitted from the computer 404. The image estimating apparatus 403 determines that processing for the captured image has been instructed, and executes the processing from step S502 or subsequent steps.

Next, in step S502, the image acquiring unit 403b acquires a captured image. In this example, the captured image is an image transmitted from the computer 404. Image information may also be acquired with the captured image and used in the steps described below. Next, in step S503, the information acquiring unit 403c acquires image information about the captured image. The image information to be acquired is the lens model (lens type), F-number, focal length, object distance, and image height, similarly to learning. Next, in step S504, the determining unit 403d determines a parameter (first image information or second image information that is predetermined) based on a comparison between the acquired image information and a threshold (first threshold) determined during learning. Next, in step S505, the image processing unit 403e generates a deblurred image (second image) from the captured image using the captured image, parameter, and previously quantized machine learning model. Next, in step S506, the image estimating apparatus 403 transmits the output image (deblurred image) to the computer 404.

This example can provide an image processing method that can perform image processing (DL deblurring) with fewer harmful effects using a quantized machine learning model.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

Each example provides an image processing method, an image processing apparatus, a method for creating a learned model, a learning apparatus, an image processing system, a storage medium, and an image processing apparatus, each of which can perform proper image processing using a quantized machine learning model. The image processing apparatus may be any apparatuses as long as it has an image processing function, and may be realized by an image pickup apparatus or a personal computer, but is not limited to these.

While the disclosure has described example embodiments, it is to be understood that some embodiments are not limited to the disclosed embodiments. The scope of the following claims is to be accorded the broadest interpretation so as to encompass all such modifications and equivalent structures and functions.

Each example can provide an image processing method that can perform proper image processing using a quantized machine learning model.

This application claims priority to Japanese Patent Application No. 2023-046288, filed on Mar. 23, 2023, and Japanese Patent Application No. 2023-222084, filed on Dec. 28, 2023, which are hereby incorporated by reference herein in its entirety.

What is claimed is:

1. An image processing method comprising:
a first step of acquiring a first image and first image information about an imaging condition or a development condition corresponding to the first image; and
a second step of generating a second image by enhancing the first image using a quantized machine learning model,
wherein in the second step, either the first image information or predetermined second image information is used as information to generate the second image, and a determination of whether to use either the first image information or the predetermined second image information as the information to generate the second image is based on a value relating to the first image information and a first threshold.

2. The image processing method according to claim 1, wherein in a case where the value relating to the first image information is equal to or smaller than the first threshold, the second step generates the second image by enhancing the first image using the first image information, and
wherein in a case where the value relating to the first image information is larger than the first threshold, the second step generates the second image by enhancing the first image using the second image information.

3. The image processing method according to claim 1, wherein the first image information is information about at least one of a type, an F-number, a focal length, an object distance, and an optical characteristic for each image height of a lens apparatus that was used for imaging corresponding to the imaging condition.

4. The image processing method according to claim 1, wherein the first image information is information about at least one of a type, sensor sensitivity, a shutter speed, and an imaging mode of an image pickup apparatus that was used for imaging corresponding to the imaging condition.

5. The image processing method according to claim 1, wherein the first image information is information about at least one of an image compression rate, a sharpness intensity, and a noise reduction intensity during development corresponding to the development condition.

6. The image processing method according to claim 1, wherein the number of bits precision for a weight for at least one layer of the machine learning model is not more than twice the number of bits precision of the first image.

7. The image processing method according to claim 1, wherein the number of bits precision of a weight for at least one of an input layer and an output layer of the machine learning model is equal to or larger than the number of bits precision of the first image.

8. The image processing method according to claim 1, wherein the second image information includes a fixed value based on the first threshold or a fixed value that does not depend on the first image information.

9. The image processing method according to claim 1, wherein the second step generates the second image by enhancing the first image using a second threshold based on the first image information and the first threshold.

10. The image processing method according to claim 1, wherein the machine learning model is previously trained with a training image having the value relating to the first image information that is equal to or smaller than the first threshold.

11. The image processing method according to claim 1, wherein the first threshold is determined based on a quantization error in a case where the machine learning model is quantized.

12. The image processing method according to claim 1, wherein enhancing of the first image is image processing of at least one of upscaling, deblurring, and noise reduction of the first image.

13. A non-transitory computer-readable storage medium storing a program that causes a computer to execute the image processing method according to claim 1.

14. An image processing apparatus comprising:
one or more memories configured to store instructions; and
at least one processor executing the instructions causing the image processing apparatus to:
an image acquiring unit configured to acquire a first image;
an information acquiring unit configured to acquire first image information about an imaging condition or a development condition corresponding to the first image;
an image processing unit configured to generate a second image by enhancing the first image using a quantized machine learning model; and
a determining unit configured to determine whether to use either the first image information or predetermined second image information as information to generate the second image based on a value relating to the first image information and a first threshold,
wherein the image processing unit enhances the first image using the machine learning model and the first image information or the second image information.

15. A learning apparatus comprising:
one or more memories configured to store instructions; and
at least one processor executing the instructions causing the learning apparatus to:
an image acquiring unit configured to acquire a first patch and a ground truth patch corresponding to the first patch;
an information acquiring unit configured to acquire first image information about an imaging condition or a development condition corresponding to the first patch;
a learning unit configured to generate a second patch by enhancing the first patch using a machine learning model based on the first patch and the first image information, and to train the machine learning model based on an error between the second patch and the ground truth patch;
a quantizing unit configured to quantize the machine learning model; and
a determining unit configured to determine a first threshold and a machine learning model having the smallest quantization error among a plurality of machine learning models trained by changing the first image information.

16. A method of making a learned model, the method comprising:
a first step of acquiring a first patch and a ground truth patch corresponding to the first patch;
a second step of acquiring first image information about an imaging condition or a development condition corresponding to the first patch;
a third step of generating a second patch by enhancing the first patch using a machine learning model based on the first patch and the first image information, and of training the machine learning model based on an error between the second patch and the ground truth patch;
a fourth step of quantizing the machine learning model; and
a fifth step of determining a first threshold and a machine learning model having the smallest quantization error among a plurality of machine learning models trained by changing the first image information.

17. A non-transitory computer-readable storage medium storing a program that causes a computer to execute the method according to claim 16.

18. An image processing apparatus communicable with the learning apparatus according to claim 15, an image processing apparatus comprising:
an image acquiring unit configured to acquire a first image;
one or more memories configured to store instructions; and
at least one processor executing the instructions causing the image processing apparatus to:
an information acquiring unit configured to acquire first image information about an imaging condition or a development condition corresponding to the first image;
an image processing unit configured to generate a second image using the quantized machine learning model; and
a determining unit configured to determine whether to use either the first image information or predetermined second image information as information to generate the second image based on a value relating to the first image information and a first threshold,
wherein the image processing unit generates the second image by enhancing the first image using the machine learning model and the first image information or the second image information.

19. An image processing system comprising:
the image processing apparatus according to claim 14; and
a processor communicable with the image processing apparatus,
wherein the processor includes a transmitter configured to transmit a request for causing the image processing apparatus to execute processing for a captured image,
wherein the image processing apparatus includes a receiver and an image processing unit,
wherein the receiver receives the request transmitted by the transmitter, and
wherein the image processing unit executes the processing for the captured image according to the request.
